(19) United States
(12) Patent Application Publication
(10) Pub. No.: US 2004/0224233 A1
(43) Pub. Date: Nov. 11, 2004

(54) Method for preparation of chemically crosslinked polyacrylonitrile polymer electrolyte as separator for secondary battery

(76) Inventors: Show -An Chen, Hsinchu City (TW); Uan-Jie Xue, Hsinchu City (TW); Jen-Jeh Lee, Taipei City (TW); Po-Shen Wang, Jiali Jen (TW)

Correspondence Address: RABIN & BERDO, P.C., Suite 500, 1101 14th Street, N.W., Washington, DC, 20005, US

(21) Appl. No.: 10/428,789

(22) Filed: May 5, 2003

(51) Int. Cl. H01M 10/40; H01M 4/58; H01M 4/60; H01M 4/40

(52) U.S. Cl. 429/303; 429/314; 429/316; 429/317; 429/307; 429/213; 429/231.95; 429/231.4

(57) ABSTRACT

A composite gel-type polymer electrolyte membrane, as a separator between the positive and the negative electrode for secondary battery, consists of crosslinked gel-type polyacrylonitrile (PAN) electrolytes, polyvinylidene fluoride (PVDF) polymers and liquid electrolytes. The crosslinked gel-type PAN electrolytes are copolymerized by acrylonitrile (AN) monomers and crosslinked monomers with two terminal acrylic acid ester function groups. The PVdF can be PVdF-co-HFP polymers containing over 80% PVdF. The liquid electrolytes are made from using nonaqueous solvents to dissolve alkaline or alkaline earth metallic salts. This invention has advantages of superior ionic conductivities and mechanical strength at high temperature, fine compatible to positive and negative electrodes and potential to be industrialized.

### BACKGROUND OF THE INVENTION

1. Field of the Invention

The present invention relates to chemically crosslinked polyacrylonitrile (PAN) polymer electrolytes, and more particularly to polymer electrolytes as separator between positive and negative electrode for secondary battery. This crosslinked polyacrylonitrile polymer electrolyte consists of polyacrylonitrile gel-type electrolytes, polyvinylidene fluoride (PVdF) and liquid electrolytes.

2. Description of the Prior Art

Advances in electronic products are rapid in the recent years. The electronic product that are portable such as notebook, cell phone, PDA, and digital recorder are getting lighter and cheaper. According to enormous consumer market, the battery industry including nickel-cadmium battery, nickel-hydrogen battery, and lithium battery is developed and advanced fleetly. The battery size is smaller, capacity is higher than conventional one, besides, battery materials are compatible to the environment.

In early 1990, Japan has succeeded in commercializing lithium ion battery. In the lithium ion battery, the positive electrodes are LiMnO₂, LiMn₂O₄, LiCoO₂, LiNiO₂ crystal powder, the negative electrodes are graphite or irregularly crystal carbon, and the separator is made of porous PP membrane or nonwoven fabrics. The separator filling with electrolytes, i.e., non-aqueous lithium salt, serves as an ionic conducting bridge. In the charge process, lithium ion moves from crystal lattice of the positive electrode to electrolytes, and then lithium ion in the electrolytes solution is moved into crystal lattice of the negative electrode. The mechanism of discharge process is reverse to that of the charge process.

The lithium battery (a secondary battery) has the advantages of high capacity, high voltage and high density; moreover, its size has potential to be minimized. Because the liquid electrolytes possibly may leak out, it must seal lithium battery closely via metal shell. Thus, it may limit lithium battery to be minimized. To overcome the leaking of the liquid electrolytes, the polymer electrolyte lithium battery is developed.

The polymer electrolyte lithium battery substitutes a separator of the conventional lithium secondary battery for the polymer electrolyte separator that can absorb liquid electrolytes to eliminate the problem of electrolytes leaking. Moreover, the adhesive property of the polymer electrolyte membrane can closely be compacted to positive and negative electrode, and also tend to simplify battery manufactures.

Armand et al. (U.S. Pat. No. 4,303,748, 1981) provided solid polymer electrolyte membrane instead of the liquid electrolyte for batteries. The solid polymer membrane consists of polymers and lithium salts. At that time, the polymer membrane was made of PEO, PPO, electrolytes salts of alkaline-metal and alkaline-earth group. Although the solid polymer electrolyte membrane has strong mechanical strength, its conductivity at room temperature is relatively low and hereby not easy to be used wildly in the battery product. After several researchers striving, the problem of low conductivity at room temperature still exits (“Polymer Electrolytes”, Fiona M. Gray, 1997, pages 37-44).

To improve the low conductivity, someone tried to add plasticizers into polymer to increase electrolyte membrane conductivity. The polymer electrolytes containing liquid electrolytes different from solid polymer electrolytes are called gel-type polymer electrolytes. Chua et al. (U.S. Pat. No. 5,240,790, 1993) mixed PAN polymer with γ-butyrolactone and lithium salts to form electrolytes, which was similar to liquid electrolytes in conductivity. But the gel-type polymer electrolyte membrane will become soft above 50° C. for long time because of its weak mechanical strength.

Luying Sun et al. from American Battery Engineering (U.S. Pat. No. 5,609,974, 1997) provided a chemically crosslinked gel-type electrolytes that mixed three monomer, which were PAN, 2-ethoxyethyl acrylate, and tri(ethylene glycol) dimethacrylate, with liquid electrolytes, and then added AIBN as an initiator finally, formed above mixture to a membrane and polymerized by heating. The chemically crosslinked gel-type electrolytes improved PAN electrolytes's defect, that is, it would be soft at high temperature, but must use cellulose filler to enhance mechanical strength. Moreover, the solution was not suitable for forming a membrane due to the low viscosity, and it would cause inefficiently compact to a positive and a negative electrode, which resulted in hardly producing battery automatically.

Gozdz et. al. from Bell Communications Research Company provided porous gel-type electrolyte membrane based on PVdF polymer to achieve higher conductivity and mechanical strength. However, the electrolytes' absorbability of polymer electrolyte membrane will decrease at high temperature, and the complex manufacture processes of membranes were not suitable for the industry.

Amano et al. form Japan NEC Company (U.S. Pat. No. 6,235,433, 2001) added PVdF into pre-polymerizing solution of crosslinked gel-type acrylic electrolytes through forming membrane and finally crosslinked-polymerized by heating. This method announced it could make the electrolyte membrane have advantages of well mechanical strength of PVdF electrolytes membrane and superior electrolytes absorbability of gel-type acrylic electrolytes. However, the solubility parameter (δ) of acrylic polymer is only 9˜10, which is far from ethylene carbonate (EC) and propylene carbonate (PC) those values of δ are 14.7 and 13.3, respectively, and causes low conductivity due to weak the absorbability. In addition, the liquid electrolytes would be withdrawn from the electrolyte membrane if it were used a long time.

The solubility parameter of PAN polymer is 15.4, that is similar to EC and PC solvent. The electrolytemembrane conductivity will rise to 4×10⁻³ S/cm or above when PAN polymer is used as membrane. (B. Scrosati, Chem, Mater. Vol. 538, page 6, 1994)

Eventually, the prior-art mentioned above has following disadvantages:

1 Since lithium secondary batteries in which liquid electrolytes may leak outside, and it must be seal closely by metal shell.

2 The conductivity of solid polymer electrolyte membrane is relatively low at room temperature.

3 The properties of the gel-type polymer electrolyte membrane are:

3.1 Weak mechanical strength, and easy to be soften at high temperature;

3.2 Not suitable for forming membrane due to low viscosity;

3.3 Inferior liquid electrolytes absorbability at high temperature;

3.4 Complex membrane forming process;

3.5 Hardly adhesive to electrode

### SUMMARY OF THE INVENTION

A primary object of the present invention is to provide a composite gel-type polymer electrolyte membrane that absorbs liquid electrolytes by PAN gel-type electrolytes, which are copolymerized by acrylonitrile (AN) monomer and crosslinkable monomer with two terminal acrylic acid ester function group. The crosslinkable monomer with two terminal acrylic acid ester function group chemically links to ethylene glycol bond which can transfer lithium ion and have superior compatible to the liquid electrolytes; thereby can absorb liquid electrolytes volume via 6-fold greater than main polymer. It can add PVdF polymer which molecule weight is over 5000, or PVdF containing over 80% PVdF-co-HFP polymer to enhance mechanical strength.

The liquid electrolytes absorbed in the interpenetrating network (IPN), which consists of a mix of PAN and PVdF polymers, are made from using nonaqueous solvent, (i.e., cyclic carbonate, acyclic carbonate, amide solvent, lactone solvent, ester solvent, etc.), to dissolve alkaline-metal or alkaline-earth metal salts. The chemical formula of crosslinked gel-type PAN electrolytes is represented by Formula I:

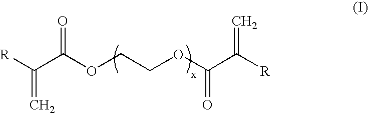

wherein R: is selected from the group consisting of hydrocarbyl of 1 to 4 carbon atoms; x: 1˜10.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is the experimental result obtained from crosslinked PAN electrolyte membrane absorbing different kind of liquid electrolytes.

FIG. 2 is the structure illustration of 2016 coin cell batteries with PVdF-PAN complex electrolyte membrane.

FIG. 3 is the experiment result of the specific capacity of the battery versus cycle number of the separator that utilizing PVdF-PAN complex electrolyte membrane as the separator of polyaniline secondary batteries (polyaniline as the positive electrode) with lithium metal.

FIG. 4 is the experiment result of specific capacity of the battery versus cycle number of the separator that utilizing PVdF-PAN complex electrolyte membrane as the separator of lithium ion batteries (LiMn₂O₄ as the positive electrode).

FIG. 5 is the experiment result of specific capacity of the battery versus cycle number of the separator that utilizing PVdF-PAN complex electrolyte membrane as the separator of polyaniline secondary batteries with carbon negative electrode.

FIG. 6 is the sectional view of three layers structure of LiCoO₂, positive electrode; crosslinked PVdF-PAN complex electrolytes membrane; and MCMB, carbon negative electrode.

### DETAILED DESCRIPTION OF THE INVENTION

The secondary batteries of which positive electrode materials are LiMnO₂, LiMn₂O₄, LiCiO₂, LiNiO₂, etc.; and the negative electrode materials are lithium metal, alloy lithium or dopants with lithium, wherein, dopants are graphite or irregulated crystalline carbon materials. The secondary batteries of organically conductive polymer of which positive materials are doped or undoped organosulfur and organosulfide polymer, polyaniline, polypyrrole, etc., those are polymerized by chemical or electrochemical method, or formed as complexes of conductive polymer and carbon black by chemically polymerization based on the surface of carbon black or graphite.

The positive and negative electrode materials mentioned above are substantially powder type, thus, it must utilize adhesive reagent to glue active powder as a membrane during manufacturing processes of electrode. Generally, the binders are PVdF, PTFE, and so on.

The present invention, composite gel-type polymer electrolyte membrane contains PVdF polymer which is compatible to binder, while coating pre-polymerizing solution to the electrode, the polymer chains will wind between the interfaces. Thus, it leads to the electrolytes closely compacting to an electrode and the adhesive interface will not dissolve in the liquid electrolytes.

Common lithium ion batteries that are not compatible to electrode, thus, it use metal shell as a material to seal and to connect between electrode and separator. This present invention, composite gel-type polymer electrolyte membrane can closely compact to electrode natively. Besides, the liquid electrolytes are absorbed in the crosslinked polymer PAN to prevent leaking. Therefore, it can be designed as cartridge a type and also as a reduction in weight and volume of batteries.

Corresponding to valuable and practical polymer electrolyte membrane, the properties of the high absorbility to liquid electrolytes, well mechanical strength, superior compatible to electrode are most important. The high absorbility to liquid electrolytes can arise the conductivity and prevent from liquid electrolytes leaking. The well mechanical strength will make the electrolyte membranes possess certain character of manufacturing process. Moreover, The superior compatible to an electrode leads to simplify package process, reduce product cost of batteries, and cause flexibility of batteries design. Most prior batteries just include either one or two items of those properties, and hardly possess all of them. However, this present invention possesses all properties mentioned above, and has advantages of easy manufacturing processes, simple package system, and flexible designs.

The solid polymer electrolytes generally consist of polyalkylene oxide, (i.e., PEO, PPO, etc.), and all kinds of alkaline metallic salts (D. E. Fenton, J. M. Parker, P. V. Wright, Polymer, 14, 589, 1973; P. V. Wright, Br. Polymer. J. 7, 319, 1975). The structure of pure PEO polymers is regular and helix and its crystal degree is 66%. And when formed coordination compounds with alkaline metallic salts, the crystal degree will arise to 70%. The conductivity of conductive solid polymer electrolytes is corresponding to the cationic movement in the uncrystal region of polymer. The cation ion can interact with several oxygen ion of EO chain (i.e., —CH₂CH₂O—), and move through by chain wriggle, thus the solid polymer electrolytes possesses conductivity property (G. Perterson, P. Jacobsson, L. M. Torell, Electrochim. Acta, 37, 1495,1992). However, the conductivity of solid polymer electrolytes is low, only at 10⁻⁸ S/cm, and will increasingly reach to the value similar to organic electrolytes at 10⁻³ S/cm only at 100° C., that can account for no application sample in fact. Since movement of ion in the uncrystal region of polymer causing the conductive property, the reduction of crystal degree of polymer is the critical point.

The gel-type polymer electrolytes have higher conductivity than that of solid polymer electrolytes because of absorbing liquid electrolytes via polymer, moreover, that make soften gel-type polymer electrolytes have superior compatible to positive and negative electrodes and lower interface resistance compared to hard solid polymer electrolytes. However, absorbing liquid electrolytes of gel-type polymer electrolytes also caused reduction of size stability and mechanical strength, and under high temperature and pressure condition, the gel-type polymer electrolytes will be soft easily and may cause current short of batteries.

The PAN system of gel-type electrolytes is the one of the field of the gel-type electrolytes that has been widely researched. Since PAN polymers enough with polarity, possess well compatible to noaqueous solvent electrolytes that are generally high polarity, and thus its conductivity is relatively high. The common process of PAN system electrolytes is that dissolves the PAN polymers (molecular weight is 10,000-1,000,000) in the excess liquid electrolytes, well stir after adding some extra components, and form the liquid phase as membrane at high temperature. After cooling, the PAN polymer membranes will be in form of the gel type. According to those gel-type electrolytes will deform under high temperature and extra force for long time, they remain safety problem when used that as a separator of batteries.

In the view of polymer batteries, both of the solid and gel-type polymer electrolytes have advantages and disadvantages in the conductivity and the mechanical strength simultaneously. These are the criteria between the conductivity and the mechanical strength. If the main chains of polymers possess major structures of both solid and gel-type polymers simultaneously, that will qualify for the properties of superior mechanical strength and high conductivity.

The present invention, composite gel-type polymer electrolytes possess superior mechanical strength and high conductivity, thereby, it can be used in the batteries industries which require the thin size, the large electric capacity, and the high energy density output, in particularly, are the gel-type polymer electrolytes of the lithium polymer secondary batteries.

The present invention, composite gel-type polymer electrolytes mainly consist of polymers with crosslinked structure and nonaqueous electrolytes.

The manufacturing process of polymers with crosslinked structure is that mixes monomers with crosslinked monomer reagent, adds the peroxides as the initial agent, and then copolymerizes them by heating or light inducing. The polymers with chemically crosslinked structures have higher temperature stability and mechanical strength than the ones without.

To mix another crosslinked polymers, (i.e., PVdF, PEO, PS, etc.) to the mixture of monomers and crosslinked monomer reagent that were mentioned above, and through copolymerizing and forming as membranes, eventually, the product possesses interpenetrating network structures. The means of combining with different polymer can lead to increase the mechanical strength of composite polymers.

The crosslinked monomer reagent that was used in this present invention has double chains in the terminal portion and —CH₂CH₂— chain in the middle portion, for examples: ethylene glycol dimethacrylate (EGD), is represented by Formula II; or triethylene glycol dimethacrylate (TGD), is represented by Formula III. Selecting the crosslinked monomer reagent with the EO chain in the middle portion is because that the unpair electrons located on oxygen atom is able to form coordination bond with oxygen ion, and result in high dissociation of positive and negative ion of alkaline metal group.

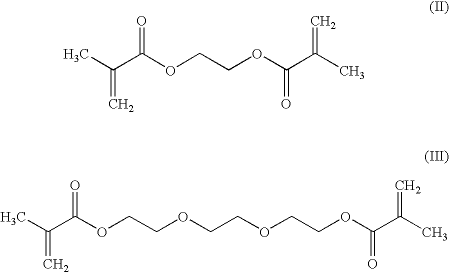

The nonaqueous liquid electrolytes consisting of organically nonaqueous solvent and metallic salts can be a function as plasticizers. The organically nonaqueous solvents are the organic solvent with high electric permittivity and dipole moment enough to dissociate salts, that are cyclic carbonate (i.e., propylene carbonate, ethylene carbonate, dimethyl carbonate, diethyl carbonate, butyl carbonate, etc.), acyclic carbonate or other organic mixture. The other organic mixture are DME, DMF, DMSO, γ-butyrolactone, N-methyl pyrrolidone, ester, lactone, and low molecular weight ether, etc. The metallic salts dissolved in nonaqueous electrolytes function as ionic conductivities medium are: LiBF₄, LiClO₄, LiPF₆, LiSbF₆, LiI, LiBr, LiCl, LiAlCl₄, LiSCN, LiAsF₆, LiCF₃SO₃, Li(CF₃SO₂)₂N, Li(C₂F₅SO₂)₂N, Li(CF₃SO₂)₃C, Li(C₂F₅SO₂)₃C, etc., further including conductive salt compounds. The concentration of the electrolytes mentioned above is generally 0 2-0.3M.

The manufacturing process of this present invention is simple, and is suitable for industrial processes. There are two different ways to produce as following: 1) the procedure of one step, that is by adding nonaqueous electrolyte solution, which is monomer solvent, during polymerizing reaction; or 2) the procedure of two steps, that is by, first, preparing crosslinked polymer membranes and nonaqueous electrolyte solution respectively, and second, then soaking the crosslinked polymer membranes in the nonaqueous electrolyte solution for absorbing.

To make sure the stability of batteries, the electrolytes, materials for making batteries, which are either liquid or gel phase must possess widely range of operation voltage. This present invention, for instance of gel-type crosslinked PAN electrolytes, its liquid electrolyte concentration is substantially equal to 1M and the decomposition potential values of different liquid electrolytes containing lithium salts are completely above 5V (vs. Li/Li⁺), in arrangement is LiPF₆>LiBF₄>LiCF₃SO₃>LiClO₄. Those results indicate that this present invention is potential to the lithium polymer secondary batteries.

In conclusion, this present invention can overcome all disadvantages of prior-art.

A primary object of the present invention is to provide a composite gel-type polymer electrolyte membrane, as the secondary battery's separator between the positive and the negative electrodes, and that possesses the advantages of high ionic conductivities, superior mechanical strength, simply manufacturing process, and well compatible to electrodes.

To achieve the object mentioned above, the crosslinked composite gel-type polymer electrolyte membrane consists of gel-type PAN electrolytes, PVdF polymers and liquid electrolytes. The gel-type PAN electrolytes are copolymerized by acrylonitrile (AN) monomers and crosslinked monomers with two terminal acrylic acid ester function groups. The PVdF polymers mean that PVdF polymers whose molecule weight is over 5000, or contain over 80% PVdF-co-HFP polymer. The liquid electrolytes are made from using nonaqueous solvent (i.e., cyclic carbonate, acyclic carbonate, amide solvent, lactone solvent, ether solvent, etc.) to dissolve alkaline or alkaline earth metallic salts. The content of liquid electrolytes is 10%˜200% of polymers of electrolyte membranes. The conductivity of the crosslinked composite gel-type polymer electrolyte membrane is above 1×10⁻⁴ S/cm. Moreover, the composite polymer electrolyte membranes can be added below 20% of PEO, soften chain polymers, or in organically porous fillers to enhance its mechanical strength.

### DESCRIPTION OF THE PREFERRED EMBODIMENTS

The AN and crosslinked monomer reagents, used in the following preferred embodiments, have already removed the stabilizer by standard purification process.

### EXAMPLE 1

### Preparation of Crosslinked Polyacrylonitrile Polymer Membranes (Excluding Electrolytes)

Add 0.5 g of PEO into the mix of 4 g of DMF, 6 g of AN monomers and 2 g of TGD, stir at the temperature under 50° C. for 6 hours until that to be the uniform solution, and then put it at room temperature. After dissolving 0.1 g of benzoly peroxide in 3 g of AN and became transparent solution, mix with the prior mixture, and then stir slowly until those as uniform gel solution. Finally, mold the uniform gel solution by the gap size of 150-250 μm, thermal polymerize by heating temperature of 60° C. for 12 h with cover, and then will obtain dry membrane of crosslinked polyacrylonitrile polymer in 150-250 μm thickness.

### EXAMPLE 2

### Preparation of Crosslinked Polyacrylonitrile Polymer Membranes (Including Electrolytes)

Weigh 1.5 g of PEO and dissolve in 20 g of 1M LiClO₄/EC/PC solution, stir and heat to reach the temperature of 100° C., and then cool at room temperature when became uniform solution. Add 0.15 g of BPO in the mix of 3.5 g of An and 1 g of TGD, stir sufficiently at room temperature, and mix with prior mixture. After stirring at room temperature and mixture became semi-transparent, mold the semi-transparent mixture by the gap size of 150-250 μm, thermal polymerize by heating temperature of 60° C. for 12 h with cover, and then will obtain crosslinked polyacrylonitrile polymer membranes in 150-250 μm thickness.

### EXAMPLE 3

### Preparation of Crosslinked Composite PVdF-PAN Gel-Type Polymer Electrolyte Membranes

The manufacturing process of gel electrolyte solution including AN monomer is similar to the procedure described in example 2.

Weigh 3 g of PVdF and dissolve in 10 g of acetone, stir and heat to reach the temperature of 50° C., and then cool at room temperature after dissolving completely. Mix that with different amount of gel electrolyte solution, stir at room temperature until solution became uniform gel solution, and then form the gel solution into thin membrane by drawknife (400 μm) onto the mold plate. Remove large amount of acetone in the dryer box, which is full of N₂ gas, for 12 h, will obtain semi-transparent membrane, and then thermal polymerize by heating temperature of 60° C. for 12 h with glass cover. After reaction completely, we can obtain the crosslinked composite gel-type polymer electrolyte membranes, PVdF, in the size of 150-250 μm.

### EXAMPLE 4

### The Thermogravimetric Analysis (TGA) Experiment of Crosslinked PAN Electrolyte Membranes and Uncrosslinked PAN Powders

Thermal stability analysis of crosslinked PAN electrolyte membranes, in the example 1, and uncrosslinked PAN powders, the results indicate that the uncrosslinked PAN powders decomposed at about temperature of 300° C.; however, the crosslinked PAN electrolyte membranes decomposed at temperature of 360-370° C. The crosslinked PAN electrolyte membranes have higher thermal stability is because of its crosslinked structures.

### EXAMPLE 5

### Swelling Test

The good solvent to PAN and PVdF are DMF and acetone, respectively. The swelling test of crosslinked composite PVdF-PAN gel-type polymer electrolyte membranes is proceeded by DMF and acetone, and the results are shown in Table 1.

TABLE 1

| Sample | Solvent | Result |
|---|---|---|
| PAN electrolyte | DMF | Dissolved |
| membranes | | completely |
| (uncrosslinked) | | |
| Crosslinked PAN | DMF | Swelling, but not |
| electrolyte | | dissolved |
| membranes | | |
| (example 1) | | |
| Crosslinked PAN | DMF | Swelling, but not |
| electrolyte | | dissolved |
| membranes | | |
| (example 2) | | |
| PVdF porous | Acetone | Dissolved |
| membranes | | completely |
| (uncrosslinked) | | |
| PVdF-PAN | Acetone | Swelling, but not |
| composite polymer | | dissolved |
| electrolyte | | |
| membranes | | |
| (example 3) | | |

Although a good solvent can diffuse into the electrolyte membranes that are prepared from example 1, 2 and 3, a solvent cannot further dissociate swelling molecular chains as to those polymer chains linked by chemically crosslinked.

### EXAMPLE 6

### Absorption Different Concentration of LiClO₄/EC/PC Electrolyte Solution via Crosslinked PAN Electrolyte Membranes

Absorption different concentrations of LiClO₄/EC/PC electrolyte solution via crosslinked electrolyte membranes prepared from example 1, measure the electrolyte solution weight absorbed by PAN electrolyte membranes and its ionic conductivities, and the results are shown in Table 2. According to PAN possessing strong polarity, PAN can absorb large amount of electrolyte solution, and its higher ionic conductivities is because of absorbing more larger amount of electrolyte solution.

TABLE 2

| | | ionic |
|---|---|---|
| Concentration of | Amount of | conductivities of |
| electrolyte | absorbed | PAN electrolyte |
| (M LiClO₄ in | electrolyte | membrane |
| EC/PC(1/1)) | solution^{a} | (10⁻³ S/cm) |
| 0.5 | 6.35 | 2.15 |
| 1 | 6.11 | 2.02 |
| 1.5 | 5.40 | 1.51 |
| 2 | 5.61 | 1.3 |

^{a}(weight of absorbed electrolyte solution/weight of dry PAN electrolyte membrane)

### EXAMPLE 7

### The Electrochemical Stability of Crosslinked PAN Electrolyte Membranes

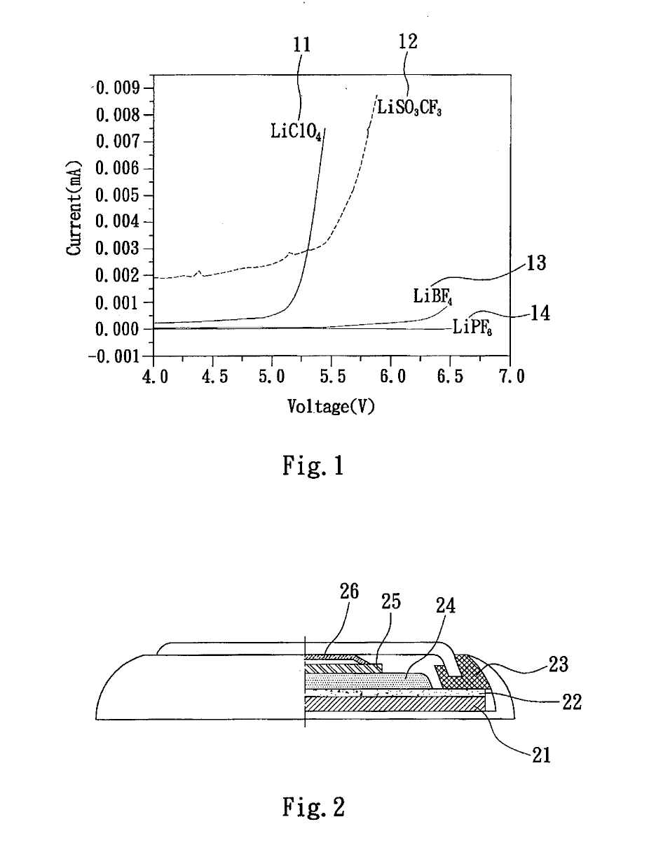

After absorbing electrolyte solution: LiClO₄(11), LiCF₃SO₃ (12), LiBF₄ (13), and LiPF₆ (14), measure the decomposition potential of the crosslinked PAN electrolyte membranes prepared from example 1, and the results are shown in FIG. 1. The experiment condition are: working electrode is steel; reference electrode is Lithium metal; scanning rate is 50 mV/S; decomposition potential vs. Li/Li⁺. The decomposition potential results are shown in Table 3, and it indicates that crosslinked gel-type PAN electrolyte membranes reveal superior electrochemical stability, its decomposition potential of 5V is great than charge potential of Lithium secondary batteries of 4V.

TABLE 3

| Electrolyte solution | Decomposition potential |
|---|---|
| (EC/PC (1/1)) | (V, vs. Li/Li⁺) |
| 1 M LiClO₄ | 5.2 |
| 1 M LiCF₃SO₃ | 5.4 |
| 1 M LiBF₄ | 6.3 |
| 1 M LiPf₆ | >6.5 |

### EXAMPLE 8

### The TGA and Ionic Conductivity Experiments of Crosslinked Composite PVdF-PAN Gel-Type Polymer Electrolyte Membranes

The different component polymers of the crosslinked composite PVdF-PAN gel-type polymer electrolyte membranes in the example 3 reveal different absorbability. Analysis of different component polymers of the crosslinked composite PVdF-PAN gel-type polymer electrolyte membranes via TGA experiment, and the results of component, amount of absorbed electrolyte solution and ionic conductivities are shown in Table 4.

TABLE 4

| Ration of | | |
|---|---|---|
| composite | Absorbed | The ionic |
| polymers | electrolyte | conductivities |
| (PVdF:PAN) | solution (%) | (10⁻³ S/cm) |
| 1:1 | 50 | 0.6 |
| 1:2 | 55.5 | 1.2 |
| 1:3 | 63.5 | 1.9 |

### EXAMPLE 9

### The Crosslinked Composite PVdF-PAN Gel-Type Polymer Electrolyte Membranes as the Separator of Lithium/Polyaniline Secondary Batteries

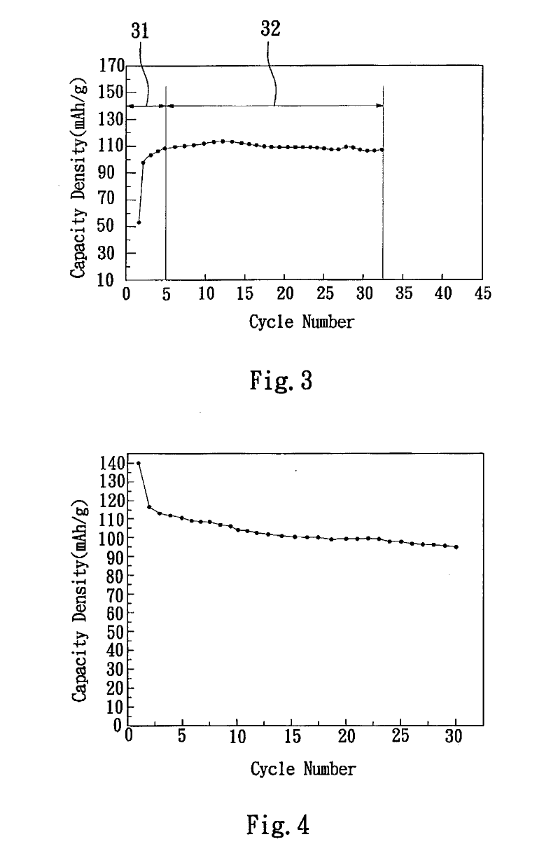

Utilizing the crosslinked composite PVdF-PAN gel-type polymer electrolyte membranes that absorbed sufficient electrolyte solution as the separator of lithium/polyaniline secondary batteries consisting of positive electrode, polyaniline carbon black complex; negative electrode, lithium metal. The structure of battery, the 2016 coin-cell battery, is shown in FIG. 2 and it consists of positive electrode (21), PVdF-PAN composite electrolyte membrane (22), gasket (23), lithium foil (24), spacer (25), and spring (26). The FIG. 3 is the results of electric capacities vs. cycle number, it displays the electric capacities reach stable within 5 cycles (31), and do not decay until the end of 30 cycles (32). Its efficiency maintains at 99%.

### EXAMPLE 10

### The Crosslinked Composite PVdF-PAN Gel-Type Polymer Electrolyte Membranes as the Separator of Lithium Ion Secondary Batteries

Utilizing the crosslinked composite PVdF-PAN gel-type polymer electrolyte membranes that absorbed sufficient electrolyte solution as the separator of lithium ion secondary batteries consisting of positive electrode, LiMn₂O₄; negative electrode, lithium metal. FIG. 4 shows the relationship diagram of electric capacities vs. cycles in the early 30 cycles The electric capacities decay is a native character of lithium secondary batteries, especially at high charging current (0.5° C.) during charging and discharging conditions. As the results shown, using the present invention, crosslinked composite PVdF-PAN gel-type polymer electrolyte membranes, as a separator of lithium secondary batteries can maintain the function of charging and discharging. Furthermore, the electric capacities tend to stable while charging cycles increasing and the efficiency remains at 99%.

### EXAMPLE 11

### The Crosslinked Composite PVdF-PAN Gel-Type Polymer Electrolyte Membranes as the Separator of Carbon/Polyaniline Secondary Batteries

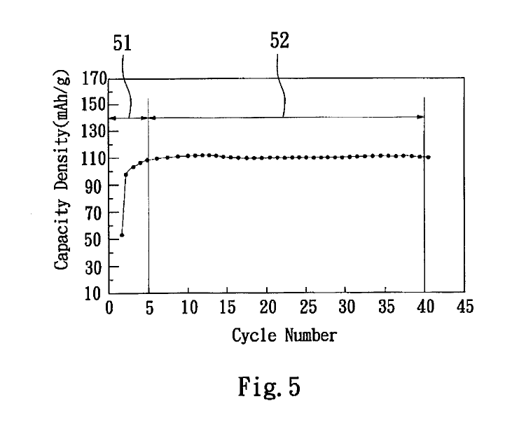

The structure is similar to a battery structure of example 9, and the batteries consist of positive electrode, polyaniline carbon black complex; negative electrode, Li-doped MCMB carbon material; separator, crosslinked composite PVdF-PAN gel-type polymer electrolyte membranes. The FIG. 5 is the results of electric capacities vs. cycle number, it displays the electric capacities reach stable within 5 cycles (51), and do not decay until the end of 40 cycles (52). Its efficiency maintains at 99%.

### EXAMPLE 12

### The Adhesive Property of Crosslinked Composite PVdF-PAN Gel-Type Polymer Electrolyte Membranes to Positive Electrode, LiCoO₂ and to Negative Electrode, MCMB Carbon

Uniformly coat the crosslinked composite PVdF-PAN gel-type polymer, the pre-polymerizing solution, to a positive electrode, LiCoO₂; a negative electrode, MCMB carbon, and then remove the acetone by purging with N₂ gas in the dryer box (the N₂ excluding H₂O and O₂). Finally, copolymerize the AN monomers and crosslinked reagent monomers by heating temperature of 60° C. for 12 h.

After the manufacturing process mentioned above, can obtain 3 layers structures that are the positive electrode, LiCoO₂; the crosslinked composite PVdF-PAN gel-type polymer electrolyte membrane; and the negative electrode, MCMB carbon. The adhesive force on the interfaces of the 3 layers is greater than that of interface between the active material and metal layer.

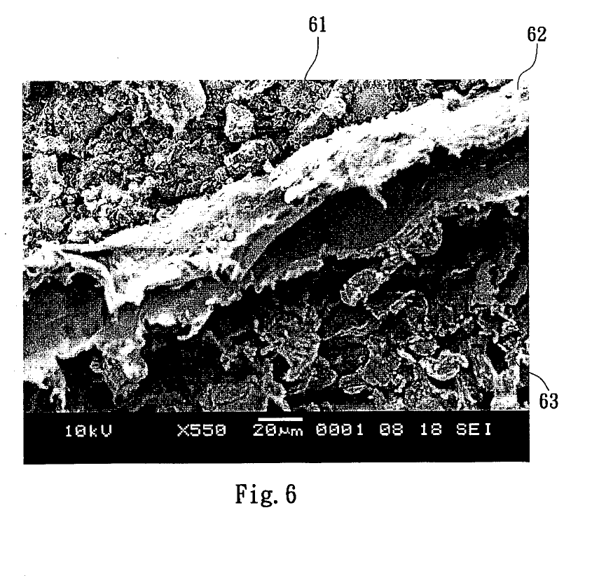

In addition, if external drawing force is applied, the peel off will take place between the active material and metal layer. Observing the cross-section by scanning electrical microscopy (SEM), and the picture is shown in the FIG. 6, wherein, upper layer is positive electrode, LiCoO₂(61); middle layer is crosslinked composite PVdF-PAN gel-type polymer electrolyte membranes (62); lower layer is negative electrode, MCMB carbon(63).

The present invention has been described with preferred embodiments thereof and it is understood that many changes and modifications in the described embodiments can be carried out without departing from the scope and the spirit of the invention as defined by the appended claims.

What is claimed is:

1. A secondary battery consists of the positive electrode, the crosslinked composite gel-type polymer electrolyte membrane and the negative electrode, wherein, crosslinked composite PVdF-PAN gel-type polymer electrolyte membrane consists of
I. crosslinked gel-type polyacrylonitrile (PAN) electrolyte that copolymerized by:
i. acrylonitrile (AN) monomers and
ii. crosslinked reagent monomers with more than two functional groups that can be copolymerized,
II. polyvinylidene fluoride (PVdF) polymers and
III. liquid electrolytes, which is absorbed in the interpenetrating network (IPN) formed of PAN and PVdF polymers.

2. A secondary battery as claimed in claim 1, wherein said crosslinked composite PVdF-PAN gel-type polymer electrolyte membrane in which liquid electrolytes weight is 10-200 percent of basis polymer of electrolyte membranes' weight.

3. A secondary battery as claimed in claim 1, wherein said the crosslinked composite PVdF-PAN gel-type polymer electrolyte membrane possesses ionic conductivities higher than 1×10⁻⁴ S/cm.

4. A secondary battery as claimed in claim 1, wherein said the crosslinked reagent monomers have a chemical structure as following: 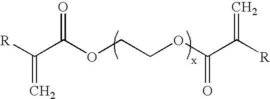
wherein R: is selected from the group consisting of hydrocarbyl of 1 to 4 carbon atoms; x: 1˜10.

5. A secondary battery as claimed in claim 1, wherein said the crosslinked gel-type polyacrylonitrile (PAN) electrolytes to which can add below 15% monomers of either acrylic acid or acrylic acid ester through copolymerizing to adhesive.

6. A secondary battery as claimed in claim 1, wherein said the polyvinylidene fluoride (PVdF) polymers which molecule weight is over 5000, or PVdF containing over 80% PVdF-co-HFP polymer to enhance the mechanical strength.

7. A secondary battery as claimed in claim 1, wherein said the crosslinked composite gel-type polymer electrolyte membrane can be added below 20% of PEO, which is soften chain polymers.

8. A secondary battery as claimed in claim 1, wherein said the crosslinked composite gel-type polymer electrolyte membrane can be added inorganically porous fillers.

9. A secondary battery as claimed in claim 1, wherein said liquid electrolytes are made from using a nonaqueous solvent to dissolve alkaline or alkaline earth metallic salts.

10. A secondary battery as claimed in claim 9, wherein said salts to make liquid electrolytes are LiBF₄, LiClO₄, LiPF₆, LiSbF₆, LII, LiBr, LiCl, LiAlCl₄, LiSCN, LiAsF₆, LiCF₃SO₃, Li(CF₃SO₂)₂N, Li (C₂F₅SO₂)₂N, Li(CF₃SO₂)₃C or Li(C₂F₅SO₂)₃C.

11. A secondary battery as claimed in claim 1, wherein said liquid electrolytes, its solvents are cyclic carbonate, acyclic carbonate, amide solvent, lactone solvent or ester solvent.

12. A secondary battery as claimed in claim 11, wherein said the liquid electrolyte solvents are propylene carbonate, ethylene carbonate, dimethyl carbonate, diethyl carbonate, butyl carbonate, DME, DMF, DMSO, γ-butyrolactone or N-methyl pyrrolidone.

13. A secondary battery as claimed in claim 1, wherein said the positive electrode is made of the lithium compounds or conductive polymers.

14. A secondary battery as claimed in claim 13, wherein said the lithium compounds are LiCoO₂, LiMnO₂, LiMn₂O₄ or LiNiO₂.

15. A secondary battery as claimed in claim 13, wherein said the conductive polymers of the positive electrode are organosulfur, organosulfide polymer, polyaniline or polypyrrole.

16. A secondary battery as claimed in claim 15, wherein said the conductivity polymers of the positive electrode are polymerized by chemical or electrochemical methods, or formed as complexes of conductive polymer and carbon black by chemically polymerization based on surface of electric carbon black or graphite.

17. A secondary battery as claimed in claim 15, wherein said the conductivity polymers of the positive electrode are doped or undoped polymers.

18. A secondary battery as claimed in claim 1, wherein said the negative electrode is made of the lithium metal, alloy lithium or dopants with lithium.

19. A secondary battery as claimed in claim 18, wherein said the dopants with lithium are graphite or irregularly crystal carbon.
